(19) United States
(12) Patent Application Publication
(10) Pub. No.: US 2020/0342056 A1
(43) Pub. Date: Oct. 29, 2020

(54) METHOD AND APPARATUS FOR NATURAL LANGUAGE PROCESSING OF MEDICAL TEXT IN CHINESE

(71) Applicant: Tencent America LLC, Palo Alto, CA (US)

(72) Inventors: Tao YANG, Mountain View, CA (US); Min TU, Cupertino, CA (US); Yaliang LI, Santa Clara, CA (US); Yusheng XIE, Mountain View, CA (US); Shangqing ZHANG, San Jose, CA (US); Kun WANG, San Jose, CA (US); Nan DU, Santa Clara, CA (US); Wei FAN, New York, NY (US)

(73) Assignee: TENCENT AMERICA LLC, Palo Alto, CA (US)

(21) Appl. No.: 16/395,439

(22) Filed: Apr. 26, 2019

(51) Int. Cl. G06F 17/27; G06F 16/31; G06N 5/02

(52) U.S. Cl. CPC G06F 17/278; G06N 5/02; G06F 16/313; G06F 17/2705

(57) ABSTRACT

A method for processing unstructured Chinese-language medical text includes identifying a medical entity in the unstructured Chinese-language medical text using an attention-based named-entity recognition (NER) model, structuring the identified medical entity using a multiple-dimensional entity understanding framework, normalizing the structured medical entity using a medical knowledge graph, and outputting the normalized medical entity.

### FIELD

The present disclosure relates to a Natural Language Processing (NLP) framework for processing and understanding medical-related content in Chinese.

### BACKGROUND

In recent years, electronic health record (EHR) and electronic medical record (EMR) systems are increasingly adopted among hospitals worldwide. An EHR system may collect a large range of medical data, both structured and unstructured data, texts and images. More specifically, a large part of the text-based clinical data is still collected and stored in the unstructured natural language form. Although great efforts have been made in structuring and formalizing the medical content, only a small amount medical contents are stored in a structured form, for example, laboratory test results, pharmacy orders. Instead, many important medical-related text contents, for example, doctors' and nurses' notes, reports, treatment plan, discharge summaries, and books, still use “free text” as their representation. Those unstructured and semi-structured data are difficult to utilize in developing modern medical artificial intelligence systems, for example, a clinical decision support system.

In addition, understanding medical text in Chinese may be more difficult than in English. For example, there are no established standards or guidelines for medical content processing and understanding in Chinese. Second, although there are some existing medical text processing frameworks in English, for example, Unified Medical Language System (UMLS) and International Statistical Classification of Diseases and Related Health Problems-10 (ICD-10), these cannot be directly transferred to Chinese, as many linguistic elements are significantly different.

### SUMMARY

In an embodiment, there is provided a method for processing unstructured Chinese-language medical text, including identifying one or more medical entities in the unstructured Chinese-language medical text using an attention-based named-entity recognition (NER) model, structuring the identified medical entities using a multiple-dimensional entity understanding framework, normalizing the structured medical entities using a medical knowledge graph, and outputting the normalized medical entities.

In an embodiment, there is provided a device comprises at least one memory configured to store program code; and at least one processor configured to read the program code and operate as instructed by the program code, the program code including: identifying code configured to cause the at least one processor to identify one or more medical entities in the unstructured Chinese-language medical text using an attention-based named-entity recognition (NER) model, structuring code configured to cause the at least one processor to structure the identified medical entities using a multiple-dimensional entity understanding framework, normalizing code configured to cause the at least one processor to normalize the structured medical entities using a medical knowledge graph, and outputting code configured to cause the at least one processor to output the normalized medical entities.

In an embodiment, there is provided a non-transitory computer-readable medium storing instructions, the instructions comprising: one or more instructions that, when executed by one or more processors of a device, cause the one or more processors to: identify one or more medical entities in the unstructured Chinese-language medical text using an attention-based named-entity recognition (NER) model; structure the identified medical entities using a multiple-dimensional entity understanding framework; normalize the structured medical entities using a medical knowledge graph; and output the normalized medical entities.

### BRIEF DESCRIPTION OF THE DRAWINGS

FIG. 1 is a diagram of an example of a natural language processing framework, according to an embodiment;

FIG. 2 is a diagram of an example environment in which systems and/or methods, described herein, may be implemented;

FIG. 3 is a diagram of example components of one or more devices of FIG. 2;

FIG. 4 is a diagram of an example of a named-entity recognition model, according to an embodiment;

FIG. 5 is a diagram of an example of a multiple-dimensional entity understanding framework, according to an embodiment;

FIG. 6 is a flow chart of an example process for implementing a natural language processing framework, according to an embodiment.

### DETAILED DESCRIPTION

In the medical field, a great number of documents are based on and use free or unstructured text as their representation. However, applying artificial intelligence techniques in the medical field may require processing, structuring, and understanding of medical-related entities. Embodiments of the present disclosure relate to a natural language processing (NLP) framework 100 for understanding medical content in Chinese, for example medical text data 104. The NLP framework 100 may include an attention-based deep named-entity recognition (NER) model 101 together with a Chinese medical dictionary to identify medical-related entities and their categories in unstructured medical text data 104. A multiple dimensional entity understanding framework 102 may be used to structurize free text content by determining a series of attributes to describe the corresponding core medical entity. In addition, a medical knowledge-graph 103 may be used to perform medical entity normalization in order to output normalized entities 105. Accordingly, NLP framework 100 may provide a feasible way to process unstructured and semi-structured medical text content in Chinese.

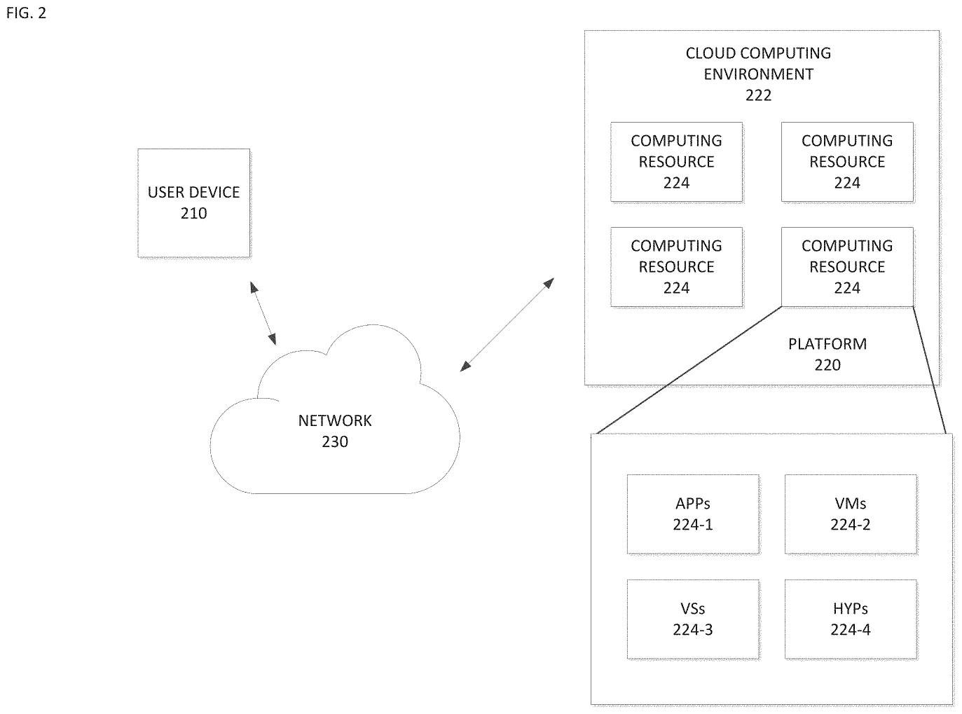

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of implementing NLP framework 100, as described elsewhere herein. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in a cloud computing environment 222. Notably, while implementations described herein describe platform 220 as being hosted in a cloud computing environment 222, in some implementations, platform 220 is not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host platform 220. The cloud resources may include computing instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210 and/or sensor device 220. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports the execution of a complete operating system (“OS”). A process virtual machine may execute a single program, and may support a single process. In some implementations, virtual machine 224-2 may execute on behalf of a user (e.g., user device 210), and may manage the infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

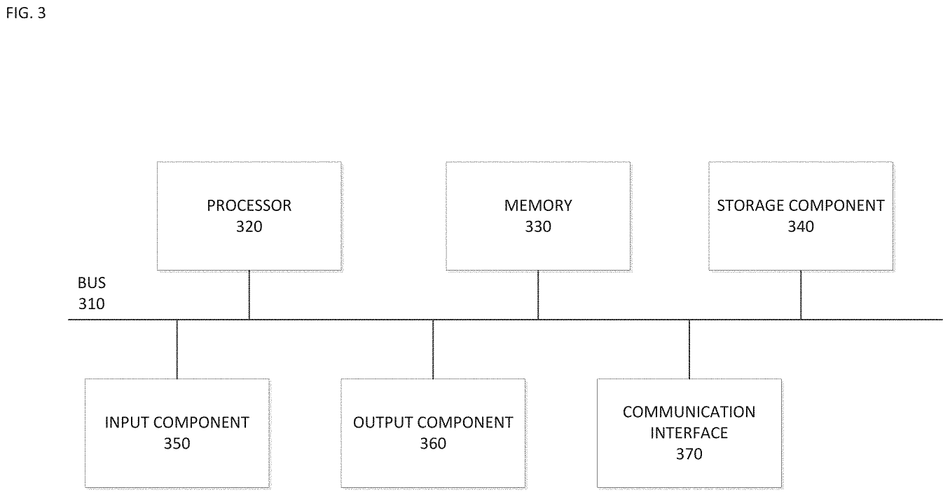

FIG. 3 is a diagram of example components of a device 300. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software. The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

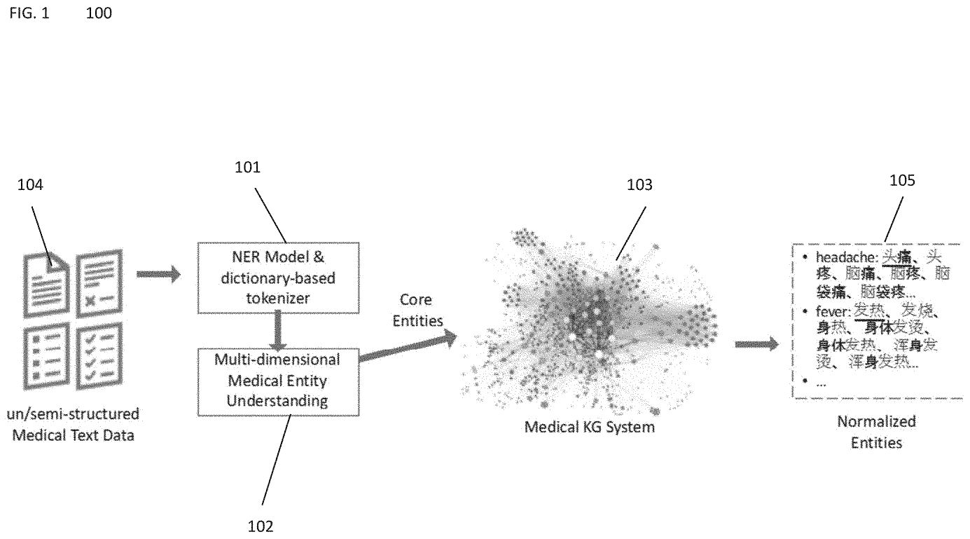

Referring again to FIG. 1, an NLP framework 100 may be used to understand unstructured or semi-structured Chinese medical text, for example medical text data 104, according to embodiments of the present disclosure. For example, NLP framework 100 may address three problems in Chinese medical NLP. First, an attention-based deep NER model 101 may be used to extract medical-related entities. Second, a multi-dimensional entity understanding framework 102 may be used to characterize the key features of a medical entity among context. Third, for the sake of entity normalization, a medical knowledge graph 103 may be used to identify the potential entity synonyms.

In embodiments, NLP framework 100 may be used to formalize medical content in Chinese. For example, a series of attributes may be defined to completely describe the characteristics of a medical entity. In addition, an attention-based character-level and word-level bidirectional LSTM-CRF deep learning model for medical-related NER in Chinese may be used. Such a model may be capable of identifying out-of-vocabulary medical entities. Further, a KG-based system may be used for medical entities normalization.

In embodiments, NLP framework 100 may address various problems of medical text processing and understanding in Chinese. NLP framework 100 may be capable of handling medical-related Chinese free text, including but not limited to, doctors' and nurses' notes, reports, treatment plan, discharge summaries, and books. NLP framework 100 may include a multi-dimensional medical entity understanding framework 102, which may address how to completely characterize the key features of a medical entity term. NLP framework 100 may also include an NER model 101 that employs the attention mechanism together with a bidirectional long short-term memory conditional random field (LSTM-CRF) NER model. The attention mechanism may improve the accuracy of sequence labeling. NLP framework 100 may include a knowledge graph 103 for discovering medical entities synonyms and normalization.

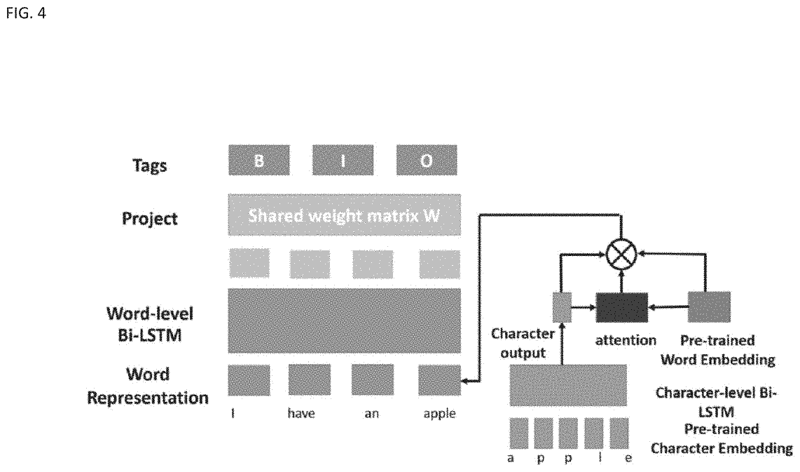

FIG. 4 illustrates an example of NER model 101, according to embodiments. NER may be a subtask of information extraction that seeks to locate and classify named entities in text into pre-defined categories. NER model 101 may relate to medical-related named entities such as diseases, symptoms, surgery, etc. In order to detect both the boundaries and the categories of the named entities, a BIO tagging system (B: begin of an entity, I: intermediate of an entity, O: out of an entity) may be used together with the categories.

NER model 101 may be used together with character-level attentions to the classical LSTM-CRF model. An example structure of the NER model 101 is shown in FIG. 4. Both word-level and character-level information are used to represent each word. These two-level embeddings may be pre-trained using the skip-gram model with large unlabeled corpora. For each word, pre-trained character embeddings may be sent to a character-level bidirectional LSTM, and the forward and backward last hidden states may be concatenated as the character-level output.

Instead of concatenating the character-level output and the pre-trained word embedding directly, the network may allow the NER model 101 to decide how to combine the information for each specific word. The two vectors may be added together using a weighted sum and send to a two-layer fully connected network. A logistic function may be added to the output to make the attention value in the range of [0,1]. The attention may be used as the weight to combine the character-level output and the pre-trained word-embedding. The weighted sum may be used as the final word representation.

The final word representation may be sent to a word-level bidirectional LSTM and the forward hidden state and the backward hidden state may be concatenated together for each word. Then a shared weighted matrix may project each word into pre-defined tags.

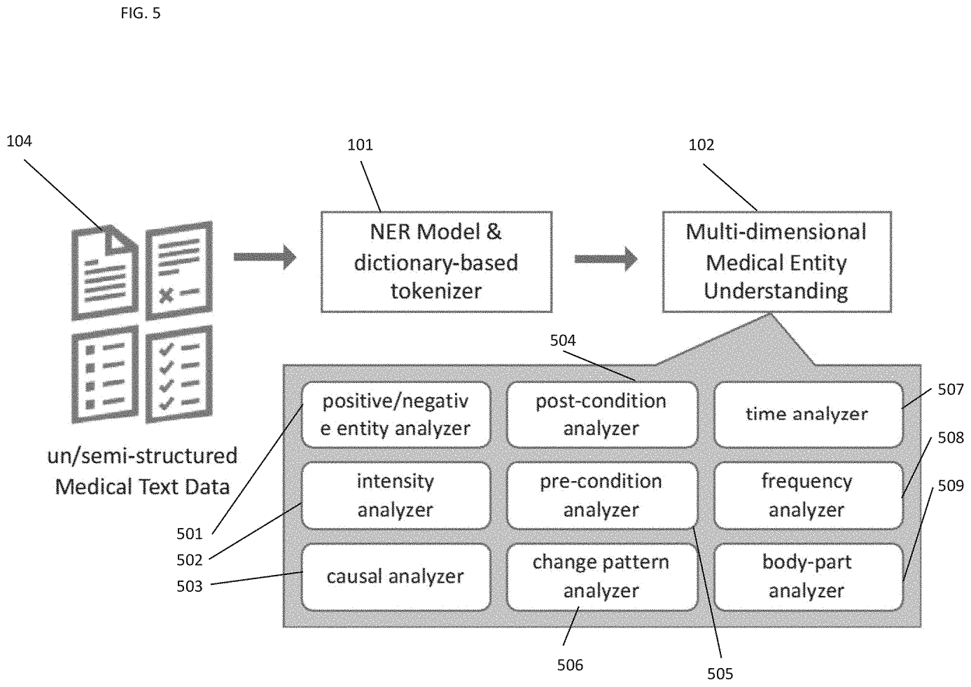

FIG. 5 illustrates an example of the multi-dimensional medical entity understanding framework 102, according to embodiments. For a medical-related entity term, the multi-dimensional medical entity understanding framework 102 may use or include one or more parsers and analyzers to extract a complete description of the entity.

Examples of embodiments of these parsers and analyzers may include one or more of the elements shown in FIG. 5. For example, positive/negative entity analyzer 201 may identify whether an entity is been denied or not, especially a negative term appears within a Chinese word. Intensity analyzer 502 may identify intensity adjective terms, for example [symbol] a little, [symbol] extremely. Causal analyzer 503 may identify what causes a sign, for example a symptom, or disease. Post-condition analyzer 504 may analyze the results of a medical treatment. Pre-condition analyzer 505 may identify some certain conditions of a sign, for example [symbol] suddenly, [symbol] irritating. Change pattern analyzer 506 may extract changes in a medical sign over time. Time analyzer 507 may extract when a medical sign happens, and the duration of the medical sign. Frequency analyzer 508 may extract frequency related terms, for example 3 times per day. Body-part analyzer 509 may identify the body part or parts associated with a medical sign.

In Chinese language medical NLP, another challenge is the topic of named entity normalization. For example, a medical fact usually has tens or hundreds of formal and informal descriptions and expressions in Chinese, and many medical entities used in Chinese are foreign words and phrases, and thus the interpretation of a foreign entity term may be various.

In embodiments, NLP framework 100 may use medical knowledge-graph 103 normalize medical entities. For example, a medical entity may be first extracted by NER model 101 and dictionary-based tokenizer, and then NLP framework 100 may use multi-dimensional medical entity understanding framework 102 to obtain a core term of the medical entity without any adjective description terms. Next, medical knowledge-graph 103 may be used to identify a centroid or normalized entity of the medical entity. The medical knowledge graph 103 may contain the relationships of medical entity aliases and its centroid term, and also provides a heuristic way to identify potential synonymous entities.

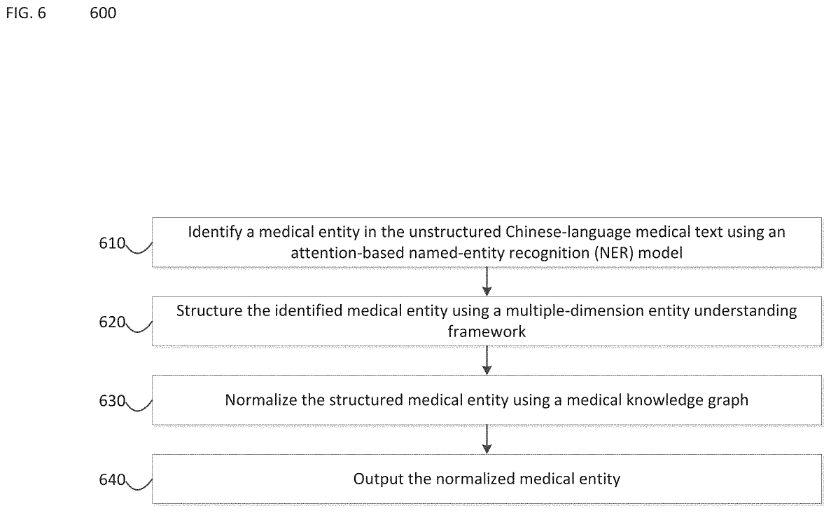

FIG. 6 is a flow chart of an example process 600 for implementing NLP framework 100. In some implementations, one or more process blocks of FIG. 6 may be performed by platform 220. In some implementations, one or more process blocks of FIG. 6 may be performed by another device or a group of devices separate from or including platform 220, such as user device 210.

As shown in FIG. 6, process 600 may include identifying a medical entity or medical entities in unstructured Chinese-language medical text using an attention-based NER model 101 (block 610).

As further shown in FIG. 6, process 600 may include structuring the identified medical entities using multiple-dimensional entity understanding framework 102 (block 620).

As further shown in FIG. 6, process 600 may include normalizing the structured medical entities using a medical knowledge graph 103 (block 630).

As further shown in FIG. 6, process 600 may include outputting the normalized medical entities (block 640).

In embodiments, the unstructured Chinese-language medical text may include at least one from among notes of a doctor, notes of a nurse, a report, a treatment plan, a discharge summary, or a book.

In embodiments, the medical entity may include at least one from among a disease, a symptom, or a medical procedure.

In embodiments, the NER model 101 may be used together with a long short-term memory conditional random field (LSTM-CRF) model to identify the medical entity.

In embodiments, each word of the medical entity may be represented by word-level information and character-level information.

In embodiments, the identifying may further include concatenating word-level embeddings with character-level embeddings using an attention value as a weighted sum.

In embodiments, the weighted sum may be sent to a word-level long short-term memory (LSTM), and a shared weighted matrix may be used to project the each word into one or more predefined tags.

In embodiments, the multiple-dimensional entity understanding framework 102 includes a plurality of analyzers.

In embodiments, the plurality of analyzers includes at least one from among a positive/negative entity analyzer, an intensity analyzer, a causal analyzer, a pre-condition analyzer, a change pattern analyzer, a post-condition analyzer, a time analyzer, a frequency analyzer, and a body part analyzer.

In embodiments, the medical knowledge graph 103 may be used to identify one or more synonymous medical entities that are synonymous to the medical entity.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for processing unstructured Chinese-language medical text, the method comprising:
identifying medical entities in the unstructured Chinese-language medical text using an attention-based named-entity recognition (NER) model;
structuring the identified medical entities using a multiple-dimensional entity understanding framework;
normalizing the structured medical entities using a medical knowledge graph;
outputting the normalized medical entities.

2. The method of claim 1, wherein the unstructured Chinese-language medical text comprises at least one from among notes of a doctor, notes of a nurse, a report, a treatment plan, a discharge summary, or a book.

3. The method of claim 1, wherein the medical entity comprises at least one from among a disease, a symptom, or a medical procedure.

4. The method of claim 1, wherein the attention-based NER model is used together with a long short-term memory conditional random field (LSTM-CRF) model to identify the medical entity.

5. The method of claim 1, wherein each word of the medical entity is represented by word-level information and character-level information.

6. The method of claim 5, wherein the identifying further comprises concatenating word-level embeddings with character-level embeddings using an attention value as a weighted sum.

7. The method of claim 6, wherein the weighted sum is sent to a word-level long short-term memory (LSTM), and a shared weighted matrix is used to project the each word into one or more predefined tags.

8. The method of claim 1, wherein the multiple-dimensional entity understanding framework comprises a plurality of analyzers.

9. The method of claim 8, wherein the plurality of analyzers includes at least one from among a positive/negative entity analyzer, an intensity analyzer, a causal analyzer, a pre-condition analyzer, a change pattern analyzer, a post-condition analyzer, a time analyzer, a frequency analyzer, and a body part analyzer.

10. The method of claim 1, wherein the medical knowledge graph is used to identify one or more synonymous medical entities that are synonymous to the medical entity.

11. A device for processing unstructured Chinese-language medical text, the device comprising:
at least one memory configured to store program code; and
at least one processor configured to read the program code and operate as instructed by the program code, the program code including:
identifying code configured to cause the at least one processor to identify medical entities in the unstructured Chinese-language medical text using an attention-based named-entity recognition (NER) model,
structuring code configured to cause the at least one processor to structure the identified medical entities using a multiple-dimensional entity understanding framework,
normalizing code configured to cause the at least one processor to normalize the structured medical entities using a medical knowledge graph, and
outputting code configured to cause the at least one processor to output the normalized medical entities.

12. The device of claim 11, wherein the unstructured Chinese-language medical text comprises at least one from among notes of a doctor, notes of a nurse, a report, a treatment plan, a discharge summary, or a book.

13. The device of claim 11, wherein the medical entity comprises at least one from among a disease, a symptom, or a medical procedure.

14. The device of claim 11, wherein the attention-based NER model is used together with a long short-term memory conditional random field (LSTM-CRF) model to identify the medical entity.

15. The device of claim 11, wherein each word of the medical entity is represented by word-level information and character-level information.

16. The device of claim 15, wherein the identifying further comprises concatenating word-level embeddings with character-level embeddings using an attention value as a weighted sum.

17. The device of claim 16, wherein the weighted sum is sent to a word-level long short-term memory (LSTM), and a shared weighted matrix is used to project the each word into one or more predefined tags.

18. The device of claim 11, wherein the multiple-dimensional entity understanding framework comprises at least one from among a positive/negative entity analyzer, an intensity analyzer, a causal analyzer, a pre-condition analyzer, a change pattern analyzer, a post-condition analyzer, a time analyzer, a frequency analyzer, and a body part analyzer.

19. The device of claim 11, wherein the medical knowledge graph is used to identify one or more synonymous medical entities that are synonymous to the medical entity.

20. A non-transitory computer-readable medium storing instructions, the instructions comprising: one or more instructions that, when executed by one or more processors of a device for processing unstructured Chinese-language medical text, cause the one or more processors to:
identify medical entities in the unstructured Chinese-language medical text using an attention-based named-entity recognition (NER) model;
structure the identified medical entities using a multiple-dimensional entity understanding framework;
normalize the structured medical entities using a medical knowledge graph; and
output the normalized medical entities.
